(19) United States
(12) Patent Application Publication
(10) Pub. No.: US 2025/0054684 A1
(43) Pub. Date: Feb. 13, 2025

(54) POWER MODULE FOR TRANS-INDUCTOR VOLTAGE REGULATOR

(71) Applicant: Monolithic Power Systems, Inc., Kirkland, WA (US)

(72) Inventors: Daocheng Huang, Santa Clara, CA (US); Ting Ge, San Jose, CA (US); Yishi Su, Hangzhou (CN); Wenyang Huang, Hangzhou (CN); Yingxin Zhou, Hangzhou (CN)

(21) Appl. No.: 18/366,564

(22) Filed: Aug. 7, 2023

(51) Int. Cl. H01F 27/28; H01F 27/245; H02M 5/12

(52) U.S. Cl. CPC H01F 27/2847; H01F 27/245; H02M 5/12

(57) ABSTRACT

A power module, having: a transformer pack; a top substrate mounted on the transformer pack; and two power device chips mounted on the top substrate, wherein each one of the power device chips has at least one pin connected to the transformer pack via the top substrate; wherein the transformer pack has a magnetic core, a first primary winding and a second primary winding, a first secondary winding and a second secondary winding, a first magnetic core part and a second magnetic core part, and wherein each one of the primary windings passes through the magnetic core, the first secondary winding is close to the first primary winding with the first magnetic core part in between, and the second secondary winding is close to the second primary winding with the second magnetic core part in between.

### TECHNICAL FIELD

The present invention relates generally to electronic circuits, and more particularly but not exclusively to power modules.

### BACKGROUND

Power converter, as known in the art, converts an input power to an output power for providing a load with required voltage and current. Trans-inductor voltage regulator (TLVR) is an ultra-fast transient performance power converter with several advantages, like fast transient and high output current. TLVR uses a winding of a transformer as an output inductor. In a multiphase TLVR circuit, each phase includes a transformer, and all the transformers share a common magnetic core. With the development of modern GPUs (Graphics Processing Units), and CPUs (Central Processing Units), increasingly high load current is required, which makes TLVR a good solution for power supply of GPUs and CPUs. Furthermore, to improve integration, the size of power modules needs to be smaller. Higher current and smaller size put more challenges to the heat conduction. Therefore, it is desirable to provide a TLVR power module with high-power density, high-efficiency and excellent heat dissipation capability in space-constrained environment.

### SUMMARY

It is an object of the present invention to provide a sandwich structure TLVR power module with transformers, power chip devices mounted and integrated in a small size module.

The embodiments of the present invention are directed to a power module. The power module includes a transformer pack, a top substrate, a first power device chip and a second power device chip. The transformer pack has a top surface and a bottom surface. The top substrate is mounted on the top surface of the transformer pack. The first power device chip and the second power device chip are mounted on a top surface of the top substrate. Each one of the first power device chip and the second power device chip has at least one pin electrically connected to the transformer pack via the top substrate. The transformer pack includes a magnetic core, a first primary winding, a second primary winding, a first secondary winding, a second secondary winding, a first magnetic core part and a second magnetic core part. Each one of the first primary winding and the second primary winding passes through the magnetic core. The first secondary winding is close to the first primary winding with the first magnetic core part in between, and the second secondary winding is close to the second primary winding with the second magnetic core part in between.

The embodiments of the present invention are directed to a transformer pack used with a power module. The transformer pack includes a magnetic core, a first primary winding, a second primary winding, a first secondary winding, a second secondary winding, a first magnetic core part and a second magnetic core part. The magnetic core has a top surface and a bottom surface. The first primary winding and the second primary winding pass through the magnetic core from the top surface to the bottom surface. The first secondary winding is placed close to the first primary winding, and the second secondary winding is placed close to the second primary winding. The first magnetic core part is placed in a gap between the first primary winding and the first secondary winding, and the second magnetic core part is placed in a gap between the second primary winding and the second secondary winding.

The embodiments of the present invention are directed to a power module. The power module includes a transformer pack, a top substrate, a bottom substrate, a first power device chip and a second power device chip. The transformer pack has a top surface and a bottom surface. The top substrate is mounted on the top surface of the transformer pack. The bottom substrate is mounted on the bottom surface of the transformer pack. The first power device chip and the second power device chip mounted on a top surface of the top substrate. Each one of the first power device chip and the second power device chip includes a switching pin, a ground pin, an input pin, a driving pin, a first power switch, a second power switch and a driver. The first power switch has a first terminal coupled to the input pin to receive an input voltage, a second terminal connected to the switching pin, and a control terminal configured to receive a first driving signal. The second power switch has a first terminal connected to the switching pin, a second terminal connected to the ground pin, and a control terminal configured to receive a second driving signal. The driver is coupled to the driving pin to receive a phase control signal, and to provide the first driving signal and the second driving signal based on the phase control signal. The switching pin is electrically coupled to the transformer pack via the top substrate.

### BRIEF DESCRIPTION OF THE DRAWINGS

The present invention can be further understood with reference to the following detailed description and the appended drawings, wherein like elements are provided with like reference numerals. The drawings are only for illustration purpose. They may only show part of the devices and are not necessarily drawn to scale.

FIG. 1 schematically shows a multi-phase TLVR 10 in accordance with an embodiment of the present invention.

FIG. 2A schematically shows a side view of a power module 20 for a dual-phase TLVR in accordance with an embodiment of the present invention.

FIG. 2B schematically shows a top view, a bottom view, a cross-sectional view of a physical layout of the power module 20 in accordance with an embodiment of the present invention.

FIG. 3 shows the disassembled view of a transformer pack 30 in accordance with an embodiment of the present invention.

FIG. 4 shows the disassembled view of a transformer pack 40 in accordance with an embodiment of the present invention.

FIG. 5 shows the disassembled view of a transformer pack 50 in accordance with an embodiment of the present invention.

FIG. 6 shows the disassembled view of a transformer pack 60 in accordance with an embodiment of the present invention.

FIG. 7 shows the disassembled view of a transformer pack 70 in accordance with an embodiment of the present invention.

FIG. 8 shows the disassembled view of a transformer pack 80 in accordance with an embodiment of the present invention.

FIG. 9 shows the disassembled view of a transformer pack 90 in accordance with an embodiment of the present invention.

FIG. 10 shows the disassembled view of a transformer pack 100 in accordance with an embodiment of the present invention.

FIG. 11 shows the disassembled view of a transformer pack 110 in accordance with an embodiment of the present invention.

FIG. 12 shows the disassembled view of a transformer pack 120 in accordance with an embodiment of the present invention.

### DETAILED DESCRIPTION

In the present invention, numerous specific details are provided, such as examples of electrical circuits and components, to provide a thorough understanding of embodiments of the invention. Persons of ordinary skill in the art will recognize, however, that the invention can be practiced without one or more of the specific details. It is noted that, for purposes of illustrative clarity, certain elements in the drawings may not be drawn to scale. In other instances, well-known details are not shown or described to avoid obscuring aspects of the invention.

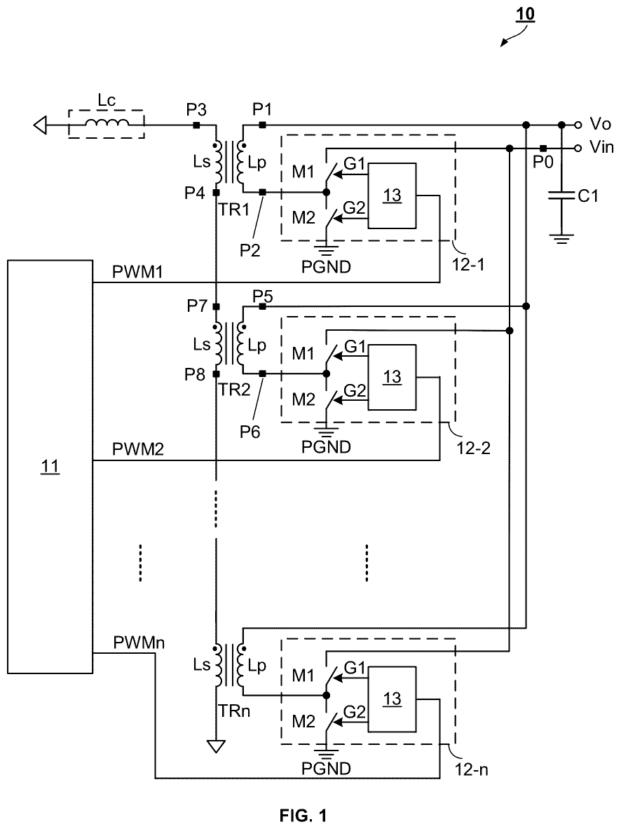

FIG. 1 schematically shows a multi-phase TLVR 10 in accordance with an embodiment of the present invention. The multi-phase TLVR 10 includes a controller block 11, a plurality of power device blocks 12 (includes 12-1˜12-n) and a plurality of transformers TR (includes TR1˜TRn), wherein n is an integer, and n>1. In FIG. 1, a power stage, also referred as a phase of the TLVR 10 includes a power device block 12 and the corresponding transformer TR. Each power device block 12 includes a first power switch M1, a second power switch M2 and a driver 13 for driving the power switches M1 and M2. The first power switch M1 has a first terminal connecting to an input terminal P0 to receive an input voltage Vin, a second terminal connecting to a switching terminal P2, and a control terminal for receiving the a driving signal G1 from the driver 13. The second power switch M2 has a first terminal connecting to the switching terminal P2, a second terminal connecting to a ground terminal for receiving a ground reference PGND, and a control terminal for receiving a driving signal G2 from the driver 13. The power switches M1 and M2 are turned on and off by the driver 13 alternately. The driving signals G1 and G2 may be in phase or out of phase, depending on the types of the power switch M1 and M2. The controller block 11 provides a plurality of phase control signals PWM1˜PWMn respectively to the corresponding power device block 12. The driver 13 receives the corresponding phase control signal PWM, and converts the phase control signal PWM to suitable driving signals for driving the power switches M1 and M2. It should be noticed that the outputs of all phases as shown in FIG. 1 are connected to work as a multi-phase converter. However, each phase output may be separate and independent, and the TLVR 10 thus could work as multiple independent converters which could have different output voltage levels for different load demands.

As shown in FIG. 1, each transformer TR includes a primary winding Lp and a secondary winding Ls. Each primary winding Lp is coupled between the corresponding power device block 12 and the output voltage Vo, and all the secondary windings Ls are coupled in series.

The TLVR 10 further includes a compensation inductor Lc for suppressing output current ripple and improving system efficiency. The compensation inductor Lc could be eliminated by a controlled leakage inductance between the primary winding Lp and the secondary winding Ls of each transformer TR. Such elimination of the compensation inductor Lc may allow for significant amounts of additional space and an increased power density on the power module with TLVR technology.

In the present invention, n could be any suitable number as required. In some embodiments, n=2, and then the TLVR 10 is used as a dual-phase power converter or two independent single-phase converters.

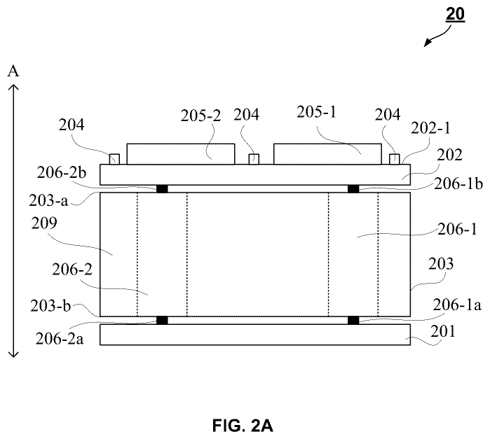

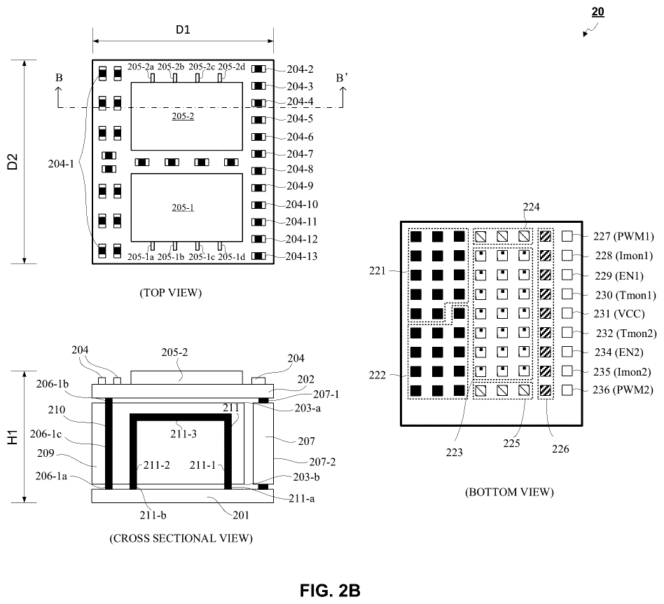

FIG. 2A schematically shows a side view of a power module 20 for a dual-phase TLVR in accordance with an embodiment of the present invention. The power module 20 may serve as power stages in FIG. 1, with n=2. The power module 20 includes: a bottom substrate 201, a top substrate 202, a transformer pack 203, power device chips 205-1 and 205-2, and discrete components 204. The discrete components 204 may include resistors and capacitors of the TLVR 10, like the input capacitors at the input terminal P0 of the TLVR 10 to filter the pulse current and stabilize the input voltage, the decoupling capacitors and filter resistors for gate driver and internal logic circuits power supplies, etc. The bottom substrate 201 and the top substrate 202 may be PCBs (Printed Circuit Board).

The bottom substrate 201 is arranged at the bottom of the power module 20. In one embodiment, the power module 20 is applied to a mainboard to supply power to the devices on the mainboard. The bottom substrate 201 is then soldered to the mainboard to connect pins/terminals/ends of the power module 20 to the mainboard via the conductive traces and pads of the bottom substrate 201. In some embodiments, the bottom substrate 201 could be removed. Then a connector is utilized for connecting the pads of the top substrate 202 to the mainboard, and the transformer pack 203 is soldered to the mainboard directly. It should be known that the connector could be configured in the embodiments with the bottom substrate 201 for transmitting the necessary signals between the top substrate 202 and the bottom substrate 201. The connector could be replaced by a plurality of metal strips covering the transformer pack 203 and connecting the top substrate 202 and the bottom substrate 201 (or the mainboard).

The transformer pack 203 has a top surface 203-a and a bottom surface 203-b. The top substrate 202 is mounted on the top surface 203-a of the transformer pack 203. The bottom substrate 201 is mounted on the bottom surface 203-b of the transformer pack 203. The transformer pack 203 has two transformers 206-1 and 206-2 integrated together, where each transformer includes a primary winding and a secondary winding, and the two transformers share a common magnetic core 209. The transformer 206-1 has a first end 206-1a and a second end 206-1b extended out from the magnetic core 209 and connecting the associated solder pads on the top substrate 202 to the associated solder pads on the bottom substrate 201. The transformer 206-2 has a first end 206-2a and a second end 206-2b extended out from the magnetic core 209 and connecting the associated solder pads on the top substrate 202 to the associated solder pads on the bottom substrate 201. Specifically, the first end 206-1a corresponds to the output voltage terminal P1 in FIG. 1 and the second end 206-1b corresponds to the switching terminal P2 in FIG. 1. Accordingly, in a dual-phase TLVR power module 20, the first end 206-2a corresponds to the output voltage terminal P5 in FIG. 1 and the second end 206-2b corresponds to the switching terminal P6 in FIG. 1.

Besides the ends 206-1a and 206-2a, the transformer pack 203 may have more ends extended out from the magnetic core 209 which may corresponds to the terminals P3, P4, P7 and P8 in FIG. 1 and to be soldered to the bottom substrate 201.

FIG. 2B schematically shows a top view, a bottom view, a cross-sectional view of a physical layout of the power module 20 in accordance with an embodiment of the present invention. The top view of the power module 20 shows a component side surface (top surface) of the top substrate 202, whereas the bottom view shows a pad side surface of the bottom substrate 201. The cross sectional view of the power module 20 shows a sectional view cut along line BB′ from the top of the power module 20. In the example of FIG. 2B, the power device chips 205-1 and 205-2, the capacitors, the resistors, and other components are mounted on the component side surface of the top substrate 202. Each one of the power device chips 205-1 and 205-2 has pins respectively connected to the corresponding discrete components 204 via the top substrate 202, and may also have pins connected to the mainboard via the top substrate 202, a connector 207 and/or the bottom substrate 201. The connector 207 in FIG. 2G has metal pillars 207-1 set in a plastic frame 207-2. The metal pillars 207-1 connect to the pads on the top substrate 202 and the pads on the bottom substrate 201 for passing necessary signals between the top substrate 202 and the bottom substrate 201.

In the example of FIG. 2B, the pad side surface of the bottom substrate 201 has pad array that electrically connect nodes of the power module 20 to components that are external to the power module 200, such as a PWM controller, like the controller block 11 in FIG. 1, etc. The pad array includes power pads 221-226 and signal pads 227-236. A pad is a mean for electrically connecting nodes and components. A pad may have a square (e.g., as in a land grid array), round (e.g., as in a ball grid array), or other shape. The power module 20 may be employed as part of a power supply, like the multi-phase TLVR 10 in FIG. 1. The terminals/pins of the power module 20 may be connected to corresponding sockets/pads on a substrate (e.g., a mainboard) of the power supply.

In the example of FIG. 2B, the power pads 221-226 are configured to transmit power between the power module 20 and the mainboard that the power module 20 is located on. The signal pads 227-236 are configured to transmit signals between the power module 20 and the mainboard that the power module 20 is located on. Each pad of the bottom substrate 201 in FIG. 2B has a square shape, e.g., 0.45 mm×0.45 mm square. The ground pads that are electrically connected to the ground reference PGND of each power device chip in FIG. 1, some of which are labeled as “223”, are depicted in dots. Not all of the ground pads are labeled for clarity of illustration. The input voltage pads that are connected to the input terminal P0 (shown in FIG. 1) are collectively labeled as “226”. The output voltage pads that are connected to the output voltage terminal P1 (shown in FIG. 1) are collectively labeled as “221”; the output voltage pads that are connected to the output voltage terminal P5 (shown in FIG. 1) are collectively labeled as “222”, the secondary winding pads that corresponds to the terminal P3 (shown in FIG. 1) are collectively labeled as “224” and the secondary winding pads that corresponds to the terminal P8 (shown in FIG. 1) are collectively labeled as “225”. Pad 227 is connected to receive the phase control signal PWM1 to the power device chip 205-1; pad 236 is connected to receive the phase control signal PWM2 to the power device chip 205-2; pad 228 is connected to provide a current monitor signal Imon1 from the power device chip 205-1; pad 235 is connected to provide a current monitor signal Imon2 from the power device chip 205-2; pad 230 is connected to provide a temperature monitoring signal Tmon1 from the power device chip 205-1; pad 232 is connected to provide a temperature monitoring signal Tmon2 from the power device chip 205-2; pad 231 is connected to receive a VCC supply voltage; pad 229 is connected to receive an enable signal EN1 for enabling the power device chip 205-1, and pad 234 is connected to receive an enable signal EN2 for enabling the power device chip 205-2. In the embodiment of FIG. 2B, the signal pads 227-236 are lined up to one side of the pad side surface of the bottom substrate 201. The input voltage pads 226 are distributed in a line adjacent to and parallel to the line of the signal pads 227-236, i.e., between the line of the signal pads 227-236 and the lines of the ground pads 223. The ground pads 223 are distributed in three lines adjacent to and parallel to the line of the input voltage pads 226, between the line of the input voltage pads 226 and the output voltage pads 221 and 222. The secondary winding pads 224 and 225 are distributed at the upper side and the lower side of the ground pads 223 in FIG. 2B, and are electrically connected to the ground pads 223. The output voltage pads 221 and 222 are distributed in three lines aligned to an opposite side of pad side surface that the signal pads 227-236 located at, whereas the output voltage pads 221 are located at the upper side of the three lines, and the output voltage pads 222 are located at the bottom side of the three lines. As can be appreciated, the pinout of the power module 20 depends on implementation details, such as the particular power device chips 205-1 and 205-2 employed. The arrangement of the pads on the pad side surface of the bottom substrate 201 may vary to suit particular applications.

The top view of the power module 20 shows the power device chip 205-1, the power device chip 205-2, various discrete components 204 (including capacitors and resistors 204-1˜204-13) mounted on the component side surface of the top substrate 202, such as input capacitors (e.g., see 204-1, distributed on the left side of the top view of the power module 20, and also between the power device chips 205-1 and 205-2), capacitors of RC filters of supply voltages for internal logic circuits (e.g., 204-3, 204-9), resistors of the RC filters of supply voltages for internal logic circuits (e.g., 204-4, 204-10), bootstrap capacitors (e.g., see 204-7, 204-13), filter capacitors of supply voltages for drivers (e.g., see 204-2, 204-5, 204-6, 204-8, 204-11, 204-12), etc. As can be appreciated, the number and type of capacitors on the power module 20 depend on the particulars of the application. Generally, the capacitors on the power module 20 have relatively low capacitance. In the example of FIG. 2B, the power device chips 205-1 and 205-2 are the tallest components on the component side surface of the top substrate 202. As shown in FIG. 2B, the power device chip 205-1 has a switching pin 205-1a, a ground pin 205-1b, an input pin 205-1c and a driving pin 205-1d. The power device chip 205-2 has a switching pin 205-2a, a ground pin 205-2b, an input pin 205-2c and a driving pin 205-2d. The output voltage pin 205-1a corresponds to the output voltage terminal P1 in FIG. 1 and is electrically coupled to the output voltage pads 221. The output voltage pin 205-2a corresponds to the output voltage terminal P5 in FIG. 1 and is electrically coupled to the output voltage pads 222. The switching pin 205-1a corresponds to the switching terminal P2 in FIG. 1 and is electrically coupled to the second end 206-1b of the transformer 206-1. The switching pin 205-2a corresponds to the switching terminal P6 in FIG. 1 and is electrically coupled to the second end 206-2b of the transformer 206-2. The ground pins 205-1b and 205-2b correspond to the ground terminal in FIG. 1 and is electrically coupled to ground pads 223 on the bottom substrate 201. The input pins 205-1c and 205-2c correspond to the input terminal PO in FIG. 1 and is electrically coupled to the input voltage pads 226 on the bottom substrate 201. Some of the pins of the power device chips 205-1 and 205-2 are shown for better understanding the structure of the power module 20. It should be appreciated that, not all of the pins of the power device chips 205-1 and 205-2 are shown in FIG. 2B, e.g., the signal pins of the power device chips 205-1 and 205-2 for electrically connecting to the signal pads on the bottom substrate 201 are not shown for clarity of the drawing. Also, the pin distribution depends on implementation details. In one embodiment, the height H1 of the power module 20 may be in a range of 5 mm-10 mm; the top substrate 202 has a width D1 of about 9 mm and a length D2 of about 10 mm.

As shown in the cross sectional view of the power module 20 in FIG. 2B, the transformer 206-1 includes a primary winding 210 and a secondary winding 211. The primary winding 210 has the first end 206-1a, the second end 206-1b and a connection part 206-1c between the first end 206-1a and the second end 206-1b. The secondary winding 211 has a first leg 211-1, a second leg 211-2 and a connecting part 211-3. The first leg 211-1 and the second leg 211-2 have a length perpendicular to the bottom PCB 201 and the top PCB 202. The connecting part 211-3 connects the first leg 211-1 and the second leg 211-2, and has a length parallel to the bottom PCB 201 and the top PCB 202. The first leg 211-1 of the secondary winding 211 has an end 211-a extended out from the bottom surface 203-b of the magnetic core 209, and is soldered to the bottom PCB 201. The second leg 211-2 of the secondary winding 211 has an end 211-b extended out from the bottom surface 203-b of the magnetic core 209, and is soldered to the bottom PCB 201. The end 211-a and the end 211-b respectively correspond to the terminals P3 and P4 in FIG. 1. Also, the transformer 206-2 has a similar structure with the transformer 206-1, and includes a secondary winding having two ends extended out from the bottom surface 203-b of the magnetic core 209, which respectively correspond to the terminals P7 and P8 in FIG. 1.

In the present invention, the transformer pack and the power device chips are mounted to save the footprint on a mainboard/substrate integrating the multi-phase TLVR 10 and the devices powered by the multi-phase TLVR 10. Each one of the power device chip 205-1 and 205-2 integrates the power device block 12 in FIG. 1, which includes the power switches M1, M2, the driver 130, and some auxiliary circuits not shown in FIG. 1. In the embodiment of FIGS. 2A and 2B, the pins of the power device chips 205-1 and 205-2 are electrically connected to the solder pads on the bottom substrate 201 via the top substrate 202, the transformer pack 203, and/or the additional connector not shown in FIGS. 2A and 2B, to make sure that all the necessary signals the mainboard needs could be obtained from the bottom substrate 201.

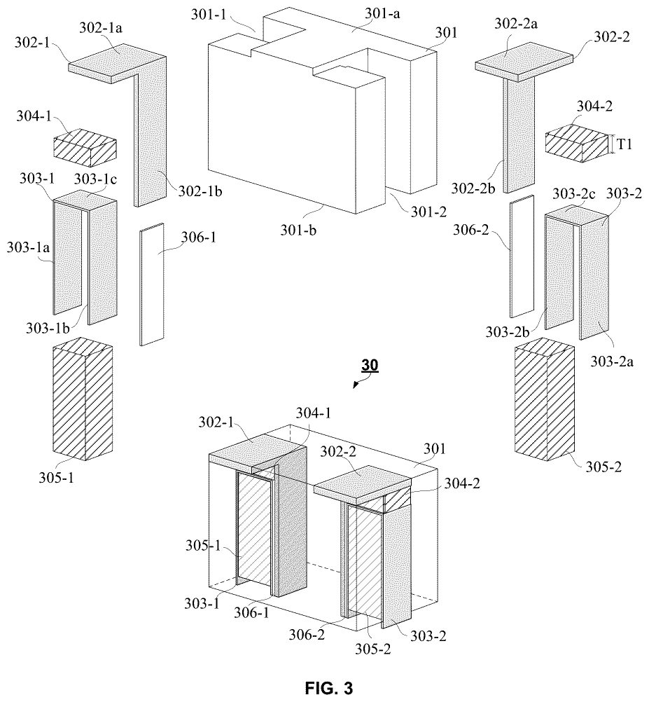

FIG. 3 shows the disassembled view of a transformer pack 30 in accordance with an embodiment of the present invention. The transformer pack 30 may be served as the transformer pack 203 in FIG. 2A. As shown in FIG. 3, the transformer pack 30 includes a magnetic core 301, two primary windings 302-1 and 302-2, two secondary windings 303-1 and 303-2, and two magnetic core parts 304-1 and 304-2. The magnetic core 301 has an “H” shape from top view, and has two passageways 301-1 and 301-2 passing through the magnetic core 301 from top to bottom. The primary windings 302-1 and 302-2 respectively passes through the two passageways 301-1 and 301-2. The secondary windings 303-1 and 303-2 are respectively arranged close to and beside the corresponding primary winding. The secondary winding 303-1 has an upside-down “U” shape with a first leg 303-1a, a second leg 303-1b and a connection part 303-1c connecting the first leg 303-1a and the second leg 303-1b. The secondary winding 303-2 has an upside-down “U” shape with a first leg 303-2a, a second leg 303-2b and a connection part 303-2c connecting the first leg 303-2a and the second leg 303-2b. The ends of the legs of the secondary winding 303-1/303-2 are soldered to the bottom substrate 201 or to the mainboard directly. Each magnetic core part 304-1/304-2 is arranged between the corresponding primary winding 302-1/302-2 and the corresponding secondary winding 303-1/303-2. In some embodiments, the transformer pack 30 further includes magnetic core parts 305-1 and 305-2 respectively under and surrounded by the corresponding “U” shape secondary winding. The material of the magnetic core parts 305-1 and 305-2 could be the same with the magnetic core 301 or could be different according to the application requirement of the power module 30. Furthermore, for preventing the short of the primary winding and the corresponding secondary winding, insulation layers 306-1 and 306-2 are respectively inserted and fill the rest space between the corresponding primary winding and secondary winding.

In the embodiment of FIG. 3, when the transformer pack 30 is used with the power module 20, the passageways 301-1 and 301-2 have a depth along an axis A perpendicular to the bottom substrate 201 and the top substrate 202 as shown in FIG. 2A.

In the embodiment of FIG. 3, the primary winding 302-1 has a first segment 302-1a bent 90 degrees to produce a tab for being soldered to the top substrate 202 and a second segment 302-1b passing through the passageway 301-1. Similarly, the primary winding 302-2 has a first segment 302-2a bent 90 degrees to produce a tab for being soldered to the top substrate 202 and a second segment 302-2b passing through the passageway 301-2. The second segments 302-1b and 302-2b are perpendicular to the top surface 301-a and the bottom surface 301-b of the magnetic core 301. This makes each one of the primary windings 302-1 and 302-2 have an “L” shape. The tab covers partial of a top surface 301-a of the magnetic core 301, i.e., the tab is extended at a plane perpendicular to the axis “A” along the depth of the passageways 301-1 and 301-2 of the magnetic core 301. The magnetic core part 304-1/304-2 is arranged between the tab of the corresponding primary winding 302-1/302-2 and the associated connection part 303-1c/303-2c of the secondary winding 303-1/303-2. In alternative embodiments, each of the primary windings 302-1 and 302-2 could further have a second segment bent 90 degrees to produce a tab for being soldered to corresponding pads on the bottom substrate 201, which makes each one of the primary windings 302-1 and 302-2 have a “Z” shape or “C” shape. Whether the primary winding has a top end or bottom end, or both, is for making a current path though the primary winding short and convenient, and meanwhile is determined by the solder pad distribution on the top substrate 202 and the bottom substrate 201.

In the embodiment of FIG. 3, the magnetic core parts 305-1 and 305-2 are separate parts. In other embodiments, the magnetic core parts 305-1 and 305-2 may be integrated within and be parts of the magnetic core 301. The material of the magnetic core parts 304-1 and 304-2 could be the same with the magnetic core 301 or could be different. The thickness “T1” of each magnetic core part 304-1/304-2 determines the leakage inductance of the corresponding transformer. In one embodiment, the thicker the thickness “T1” of each magnetic core part 304-1/304-2, the larger the leakage inductance of the corresponding transformer. In a typical application when the power module has a thickness of 10 mm, the thickness “T1” of the magnetic core part 304-1/304-2 is 0.5-1 mm.

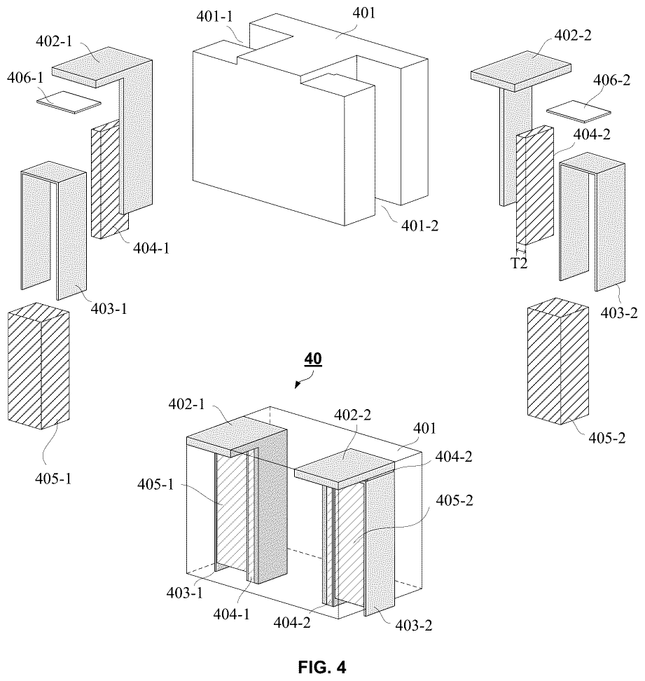

FIG. 4 shows the disassembled view of a transformer pack 40 in accordance with an embodiment of the present invention. The transformer pack 40 may be served as the transformer pack 203 in FIG. 2A. As shown in FIG. 4, the transformer pack 40 is similar with the transformer pack 30 with the difference that the locations of the magnetic core parts 404-1/404-2 and the insulation layers 406-1/406-2 are swapped. Specifically, the magnetic core part 404-1/404-2 is arranged in the gap between the corresponding primary winding 402-1/402-2 and the corresponding secondary winding 403-1/403-2 along the corresponding passageway 401-1/401-2. In the embodiment of FIG. 4, the thickness “T2” of the magnetic core part 404-1/404-2 determines the leakage inductance of the corresponding transformer. In one embodiment, the larger the thickness “T2” of each magnetic core part 404-1/404-2, the larger the leakage inductance of the corresponding transformer. In a typical application, the thickness “T2” of the magnetic core part 404-1/404-2 is 0.5-1 mm.

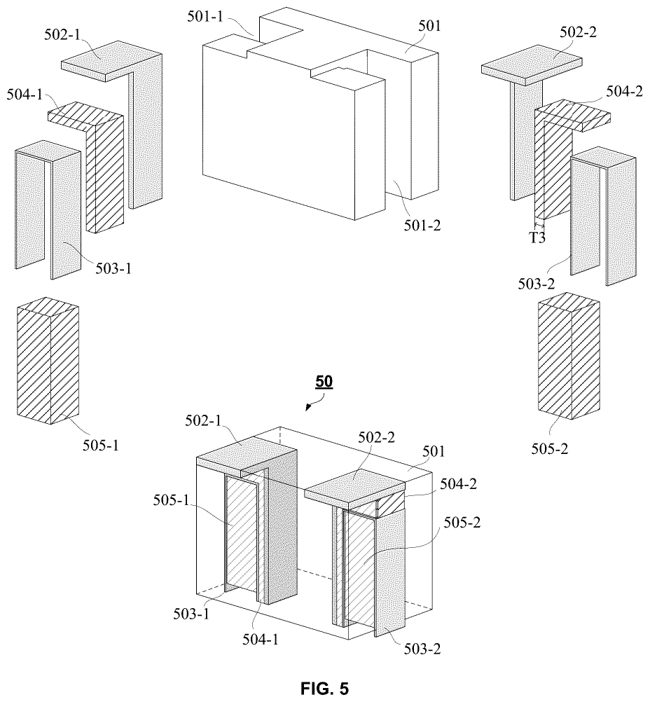

FIG. 5 shows the disassembled view of a transformer pack 50 in accordance with an embodiment of the present invention. The transformer pack 50 may be served as the transformer pack 203 in FIG. 2A. As shown in FIG. 5, the transformer pack 50 is similar with the transformer pack 30 with the difference that almost all the space/gap between the primary winding and the corresponding secondary winding is filled with corresponding magnetic core part 504-1/504-2. Specifically, each magnetic core part 504-1/504-2 has a similar “L” shape with the primary winding 502-1/502-2, and is arranged between the corresponding primary winding and the corresponding secondary winding. Each magnetic core part 504-1/504-2 has a first part along the corresponding passageway 501-1/501-2, and a second part perpendicular to the first part. In the embodiment of FIG. 5, the thickness “T3” of the magnetic core part 504-1/504-2 determines the leakage inductance of the corresponding transformer. In one embodiment, the larger the thickness “T3” of each magnetic core part 504-1/504-2, the larger the leakage inductance of the corresponding transformer. In a typical application, the thickness “T3” of the magnetic core part 504-1/504-2 is 0.5-1 mm. In the embodiment of FIG. 5, since all the space/gap between the primary winding and the corresponding secondary winding is substantially filled by the magnetic core part 504-1/504-2, the insulation layer is omitted.

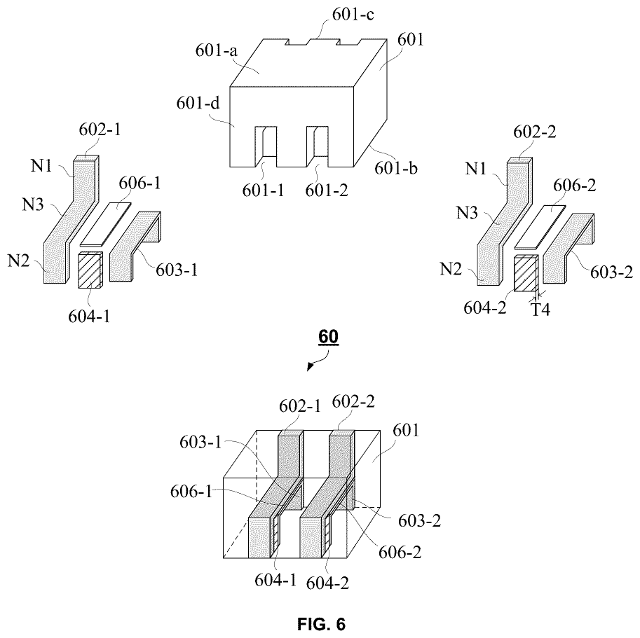

FIG. 6 shows the disassembled view of a transformer pack 60 in accordance with an embodiment of the present invention. The transformer pack 60 may be served as the transformer pack 203 in FIG. 2A. As shown in FIG. 6, the transformer pack 60 includes a magnetic core 601, two primary windings 602-1 and 602-2, two secondary windings 603-1 and 603-2, and two magnetic core parts 604-1 and 604-2. The magnetic core 601 is a cube, and has two “N” shape passageways 601-1 and 601-2 passing through the magnetic core 601 from top to bottom. The primary windings 602-1 and 602-2 respectively passes through the two passageways 601-1 and 601-2, and each primary winding 602-1/602-2 has a corresponding “N” shape adapted to the passageway 601-1/601-2. As shown in FIG. 6, each primary winding 602-1/602-2 has a first segment N1, a second segment N2 and a third segment N3. The first segment N1 is extended from a top surface 601-a of the magnetic core 601 to an interior of the magnetic core 601, and has a length perpendicular to the top surface 601-a, i.e., along the axis “A” as shown in FIG. 2A. The second segment N2 is extended from a bottom surface 601-b of the magnetic core 601 to the interior of the magnetic core 601, and has a length perpendicular to the bottom surface 601-b, i.e., along the axis “A” as shown in FIG. 2A. The third segment N3 connects the first segment N1 and the second segment N2 inside the magnetic core 601. In one embodiment, the third segment N3 has a length parallel to the top surface 601-a and the bottom surface 601-b. The secondary windings 603-1 and 603-2 are respectively placed close to the corresponding primary windings 602-1/602-2, and is under third segment N3 of the corresponding primary winding 602-1/602-2, wherein each secondary winding 603-1/603-2 has an upside-down “U” shape with two legs and a connection part connecting the two legs. Each leg has an end soldered to the bottom substrate 201 or to the mainboard directly.

Each magnetic core part 604-1/604-2 is located between the corresponding primary winding and the corresponding secondary winding, and is along the second segment N2 of the corresponding primary winding 602-1/602-2, as shown in FIG. 6. For preventing the short of the primary winding to the corresponding secondary winding, insulation layers 606-1 and 606-2 are respectively inserted between the corresponding primary winding and secondary winding, and is along the third segment N3 of the corresponding primary winding 602-1/602-2.

In the embodiment of FIG. 6, the first segment N1 of the primary winding 602-1 and the first segment N1 of the primary winding 602-2 are aligned to a first side surface 601-c of the magnetic core 601. The second segment N2 of the primary winding 602-1 and the second segment N2 of the primary winding 602-2 are aligned to a second side surface 601-d of the magnetic core 601. The first side surface 601-c and the second side surface 601-d of the magnetic core 601 are opposite. The surfaces of the first segment N1 and second segment N2 of each primary winding at the side surfaces of the magnetic core 601 are exposed to the corresponding side surface in FIG. 6. It should be understood that the first segment N1 and second segment N2 of each primary winding could also be covered and totally inside the magnetic core 601, i.e., except for the ends extended out from the top surface 601-a and bottom surface 601-b of the magnetic core 601, the other parts of the primary windings 602-1/602-2 are covered by and inside the magnetic core 601.

In the embodiment of FIG. 6, the magnetic core parts 604-1 and 604-2 are arranged between the third segment N3 of corresponding primary winding and the middle part of the upside-down “U” shape secondary winding as shown in FIG. 3, i.e., the magnetic core parts 604-1 and 604-2 are placed inside the magnetic core 601, at a plane parallel to the top surface 601-a and bottom surface 601-b of the magnetic core 601. The material of the magnetic core parts 604-1 and 604-2 could be the same with the magnetic core 601 or could be different. The thickness “T4” of each magnetic core part 604-1/604-2 determines the leakage inductance of the corresponding transformer. In one embodiment, the thicker the thickness “T4” of each magnetic core part 604-1/604-2, the larger the leakage inductance of the corresponding transformer. In a typical application, the thickness “T4” of the magnetic core part 604-1/604-2 is 0.5-1 mm.

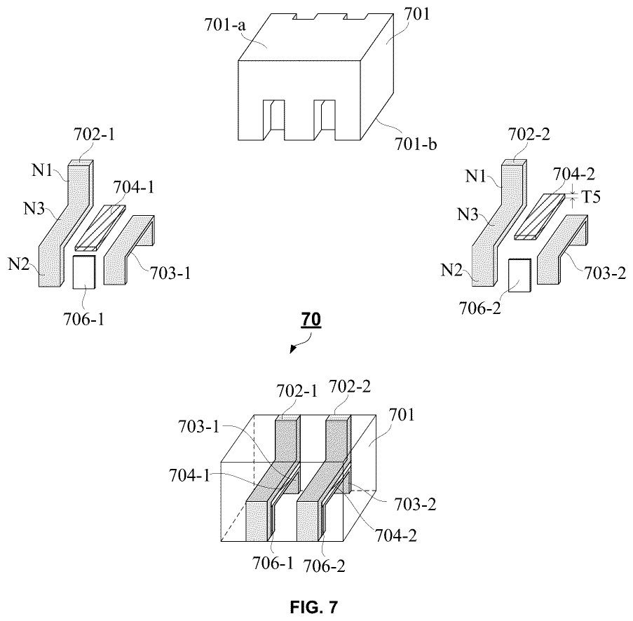

FIG. 7 shows the disassembled view of a transformer pack 70 in accordance with an embodiment of the present invention. In FIG. 7, compared with the embodiment in FIG. 6, the positions of the magnetic core parts and the insulation layers are swapped. In FIG. 7, each of the magnetic core parts 704-1/704-2 is arranged between the third segment N3 of the corresponding primary winding 702-1/702-2 and the middle part of the corresponding secondary winding 703-1/703-2. In this case, the thickness “T5” of the magnetic core part 704-1/704-2 determines the leakage inductance of the corresponding transformer.

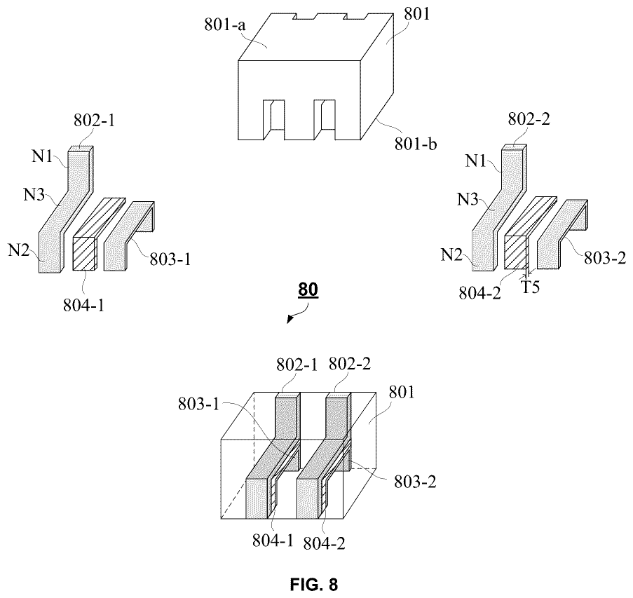

FIG. 8 shows the disassembled view of a transformer pack 80 in accordance with an embodiment of the present invention. In FIG. 8, almost all the space/gap between the primary winding and the corresponding secondary winding is substantially filled by the magnetic core part 804-1/804-2, like the embodiment in FIG. 5. In this case, each magnetic core part 804-1/804-2 has an “L” shape, and the thickness “T5” of the magnetic core part 804-1/804-2 determines the leakage inductance of the corresponding transformer.

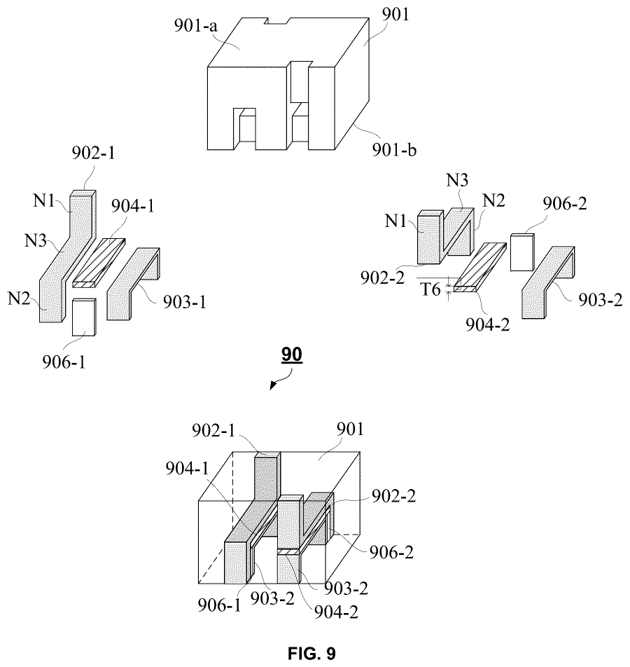

FIG. 9 shows the disassembled view of a transformer pack 90 in accordance with an embodiment of the present invention. Compared with the embodiment in FIG. 7, the primary windings 902-1 and 902-2 are inversely placed. As can be seen from FIG. 9, the first segment N1 of the primary winding 902-1 and the first segment N1 of the primary winding 902-2 are arranged in the opposite side surfaces of the magnetic core 901. Correspondingly, the second segment N2 of the primary winding 902-1 and the second segment N2 of the primary winding 902-2 are located in the opposite side surfaces of the magnetic core 901 too. Specifically, the first segment N1 of the primary winding 902-1 and the second segment N2 of the primary winding 902-2 are aligned to a same side surface of the magnetic core 901, and the second segment N2 of the primary winding 902-1 and the first segment N1 of the primary winding 902-2 are aligned to a same side surface of the magnetic core 901. Like the embodiment in FIG. 7, the thickness “T6” of the magnetic core part 904-1/904-2 determines the leakage inductance of the corresponding transformer.

In some embodiments, the magnetic core part 904-1/904-2 and the corresponding insulation layer 906-1/906-2 could swap positions. In some embodiments, the insulation layers 906-1 and 906-2 are removed, and the magnetic core part 904-1/904-2 respectively extend to substantially fill all the space/gap between the primary winding 902-1/902-2 and the corresponding secondary winding 903-1/903-2, like the embodiment in FIG. 8.

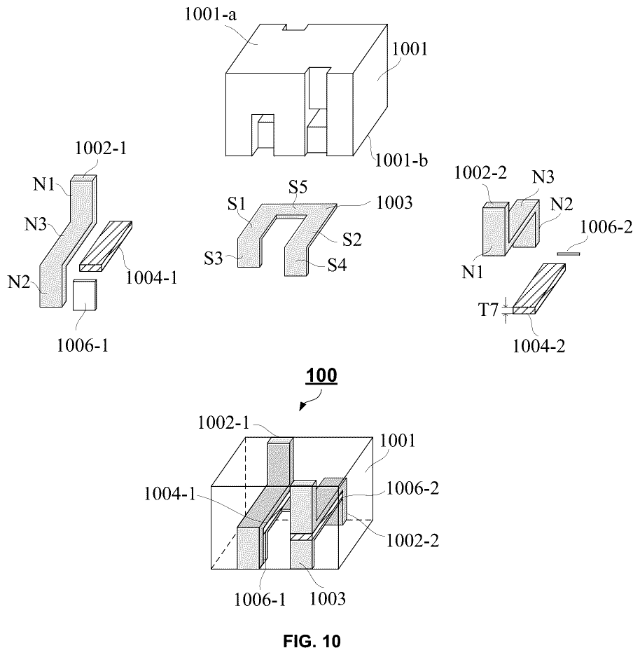

FIG. 10 shows the disassembled view of a transformer pack 100 in accordance with an embodiment of the present invention. Compared with the embodiment in FIG. 9, the legs of secondary windings at one same side are removed, and the connecting parts of the secondary windings are connected by a segment inside the magnetic core 1001. Then the secondary windings are connected inside the magnetic core 1001 to form an integral piece, i.e., a secondary winding 1003. Specifically, the secondary winding 1003 has a first segment S1, a second segment S2, a third segment S3, a fourth segment S4 and a fifth segment S5. The first segment S1 is under and parallel to a third segment N3 of the primary winding 1002-1. The second segment S2 is under and parallel to a third segment N3 of the primary winding 1002-2. The third segment S3 and the fourth segment S4 are respectively extended from the first segment S1 and the second segment S2 to a bottom surface 1001-b of the magnetic core 1001. The fifth segment S5 connects the first segment S1 and the second segment S2 inside the magnetic core 1001.

Similar with the aforementioned embodiments of the present invention, the magnetic core part 1004-1 and the insulation layer 1006-1 could swap positions, and meanwhile, the magnetic core part 1004-2 and the insulation layer 1006-2 could swap positions too. The shape and size of the magnetic core parts and the insulation layers are adjusted accordingly when the positions are swapped. In some embodiments, the insulation layers 1006-1 and 1006-2 are removed, and the magnetic core part 1004-1/1004-2 respectively extend to substantially fill all the space/gap between the primary winding 1002-1/1002-2 and the secondary winding 1003.

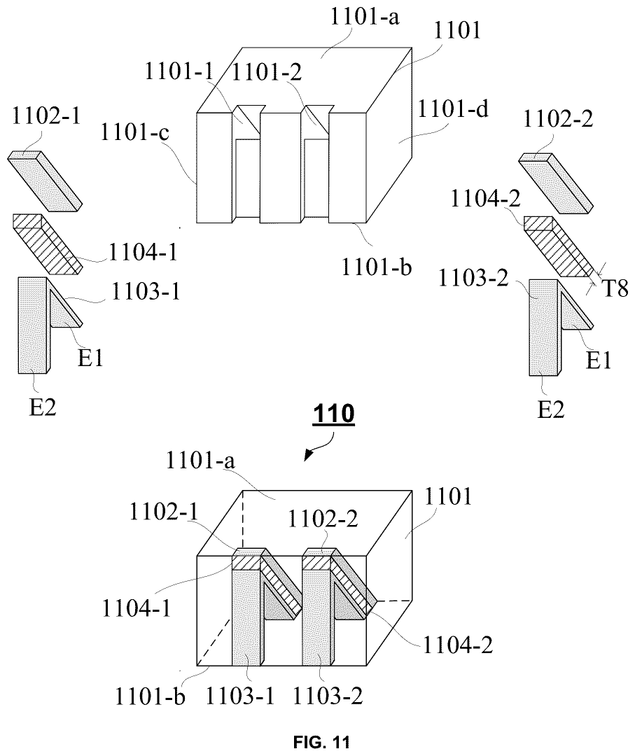

FIG. 11 shows the disassembled view of a transformer pack 110 in accordance with an embodiment of the present invention. The transformer pack 110 may be served as the transformer pack 203 in FIG. 2A. As shown in FIG. 11, the transformer pack 110 includes a magnetic core 1101, two primary windings 1102-1 and 1102-2, two secondary windings 1103-1 and 1103-2, and two magnetic core parts 1104-1 and 1104-2. The magnetic core 1101 is a cube, and has two passageways 1101-1 and 1101-2 passing through the magnetic core 1101 from top to bottom in a slant angle. The two passageways 1101-1 and 1101-2 are straight and parallel with each other. The two primary windings 1102-1 and 1102-2 respectively passes through the passageways 1101-1 and 1101-2. In one embodiment, the projections of the two primary windings 1102-1 and 1102-2 to a first side surface 1101-c of the magnetic core 1101 are overlapped, and the projections of the two primary windings 1102-1 and 1102-2 to a second side surface 1101-d of the magnetic core 1101 are overlapped too. The first side surface 1101-c and the second side surface 1101-d are opposite. The secondary windings 1103-1 and 1103-2 are respectively placed close to and under the corresponding primary windings 1102-1 and 1102-2, wherein each secondary winding 1103-1/1103-2 has an upside-down “V” shape with two segments/legs E1 and E2. The ends of the two legs could be soldered to the bottom substrate 201 or to the mainboard directly. The segment/leg E1 of the secondary winding 1103-1/1103-2 is parallel to the corresponding primary winding 1102-1/1102-2, and the other segment/leg E2 of the secondary winding 1103-1/1103-2 are exposed at the corresponding side surface as shown in FIG. 11. The ends of the two primary windings 1102-1 and 1102-2 at a top surface 1101-a of the magnetic core 1101 are aligned in a line paralleled to the side surface that the segment/leg E2 of the secondary winding 1103-1/1103-2 are exposed to. It should be understood that the segment/leg E2 of the secondary winding 1103-1/1103-2 could be unexposed and be inside the magnetic core 1101 in alternative embodiments. In one embodiment, the projections of the two secondary windings 1103-1 and 1103-2 to the first side surface 1101-c are overlapped, and the projections of the two secondary windings 1103-1 and 1103-2 to the second side surface 1101-d are overlapped too. The gap/space between the primary winding 1102-1/1102-2 and the corresponding secondary winding 1103-1/1103-2 is filled by the corresponding magnetic core part 1104-1/1104-2. The thickness “T8” of the magnetic core part 1104-1/1104-2 determines the leakage inductance of the corresponding transformer.

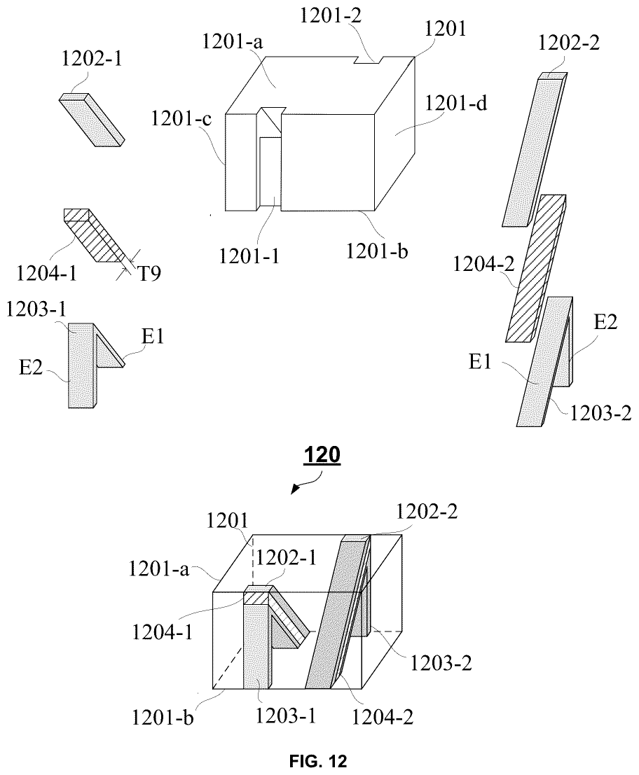

FIG. 12 shows the disassembled view of a transformer pack 120 in accordance with an embodiment of the present invention. The transformer pack 120 may be served as the transformer pack 203 in FIG. 2A. The primary windings 1202-1 and 1202-2 are inversely placed compared with the primary windings 1102-1 and 1102-2 in FIG. 11. Specifically, the ends of the primary windings 1202-1 and 1202-2 extended out of a top surface 1201-a of the magnetic core 1201 are located in the opposite sides of the top surface 1201-a. Accordingly, the ends of the primary windings 1202-1 and 1202-2 extended out of a bottom surface 1201-b of the magnetic core 1201 are located in the opposite sides of the bottom surface 1201-b. In one embodiment, the projections of the two primary windings 1202-1 and 1202-2 to a first side surface 1201-c of the magnetic core 1201 are crossed, and the projections of the two primary windings 1202-1 and 1202-2 to a second side surface 1201-d of the magnetic core 1201 are crossed too. The first side surface 1201-c and the second side surface 1201-d are opposite. Accordingly, a segment/leg E1 of the secondary winding 1203-1 is parallel to the corresponding primary winding 1201-1, and the other segment/leg E2 of the secondary winding 1203-1 is exposed at the corresponding side surface as shown in FIG. 12. The segment/leg E1 of the secondary winding 1203-2 is parallel to the corresponding primary winding 1201-2, and the other segment/leg E2 of the secondary winding 1203-2 is exposed at the corresponding side surface as shown in FIG. 12. It should be understood that the segments/legs E2 of the secondary winding 1203-1/1203-2 could be unexposed and be inside the magnetic core 1201. In one embodiment, the projections of the segments/legs E1 of the secondary windings 1203-1 and 1203-2 to the first side surface 1201-c are crossed, and the projections of segments/legs E1 of the two secondary windings 1203-1 and 1203-2 to the second side surface 1201-d are crossed too. The gap/space between the primary winding 1202-1/1202-2 and the corresponding secondary winding 1203-1/1203-2 is filled by the corresponding magnetic core part 1204-1/1204-2. The thickness “T9” of the magnetic core part 1204-1/1204-2 determines the leakage inductance of the corresponding transformer.

In the aforementioned embodiments, dual-phase power modules are illustrated for clearly introduce the present invention. It should be understood that some embodiments of the present invention could include multi-phase (more than two) power module. The numbers of the primary windings and the corresponding secondary windings in a magnetic core, the power device chips mounted on the magnetic core could be scaled up to form a multi-phase power module. Meanwhile, single-phase power modules with a transformer pack having a single primary winding passing through a magnetic core and a corresponding secondary winding are in the spirit and the scope of the invention.

In some embodiments of the present invention, the magnetic core and the magnetic core parts of the transformer pack may be made of the same material, but have different geometries and/or percent composition to meet an inductance-current requirement of a target inductance profile of the transformers. In alternative embodiments, the magnetic core parts of the magnetic core may be made of different materials, like ferrite, iron powder, and any other suitable magnetic material to obtain a target inductance profile.

In the present invention, to make the transformer packs have planar surfaces, the ends of the primary windings and any other metal layers that cover the surfaces of the magnetic cores are damascened into the magnetic core surfaces as shown in FIGS. 3-12.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A power module, comprising:
a transformer pack having a top surface and a bottom surface;
a top substrate mounted on the top surface of the transformer pack; and
a first power device chip and a second power device chip mounted on a top surface of the top substrate, wherein each one of the first power device chip and the second power device chip has at least one pin electrically connected to the transformer pack via the top substrate; wherein
the transformer pack comprises:
a magnetic core;
a first primary winding and a second primary winding;
a first secondary winding and a second secondary winding; and
a first magnetic core part and a second magnetic core part; and wherein
each one of the first primary winding and the second primary winding passes through the magnetic core, the first secondary winding is close to the first primary winding with the first magnetic core part in between, and the second secondary winding is close to the second primary winding with the second magnetic core part in between.

2. The power module of claim 1, further comprising a bottom substrate mounted on the bottom surface of the transformer pack.

3. The power module of claim 1, wherein:
each one of the first primary winding and the second primary winding passes through the magnetic core from the top surface to the bottom surface of the transformer pack; and
each one of the first secondary winding and the second secondary winding has two ends extended out of the bottom surface of the transformer pack.

4. The power module of claim 1, wherein:
each one of the first primary winding and the second primary winding has a segment passing through the magnetic core straightly and perpendicular to the top surface and the bottom surface of the magnetic core; and
each one of the first secondary winding and the second secondary winding has an upside-down “U” shape with two legs and a middle part connecting the two legs, wherein one of the legs of the first secondary winding is close to and parallel to the first primary winding, and one of the legs of the second secondary winding is close to and parallel to the second primary winding.

5. The power module of claim 4, wherein the transformer pack further comprises:
a third magnetic core part half surrounded by the first secondary winding; and
a fourth magnetic core part half surrounded by the second secondary winding.

6. The power module of claim 1, wherein:
each one of the first primary winding and the second primary winding passes through the magnetic core in a slant angle from the top surface to the bottom surface of the transformer pack; and
each one of the first secondary winding and the second secondary winding has an upside-down “V” shape with two legs, wherein one of the legs of the first secondary winding is close to and parallel to the first primary winding, and one of the legs of the second secondary winding is close to and parallel to the second primary winding.

7. The power module of claim 1, wherein:
each one of the first primary winding and the second primary winding has a “N” shape with a first segment extended from a top surface to an interior of the magnetic core, a second segment extended from a bottom surface to the interior of the magnetic core, and a third segment connecting the first segment and the second segment inside the magnetic core; and
each one of the first secondary winding and the second secondary winding has an upside-down “U” shape with two legs and a middle part connecting the two legs, wherein the middle part of the first secondary winding is under the third segment of the first primary winding with the first magnetic core part in between, the middle part of the second secondary winding is under the third segment of the second secondary winding with the second magnetic core part in between, and wherein one of the legs of the first secondary winding is close to and parallel to the second segment of the first primary winding, and one of the legs of the second secondary winding is close to and parallel to the second segment of the second primary winding.

8. A transformer pack, comprising:
a magnetic core having a top surface and a bottom surface;
a first primary winding and a second primary winding passing through the magnetic core from the top surface to the bottom surface;
a first secondary winding and a second secondary winding, wherein the first secondary winding is placed close to the first primary winding, and the second secondary winding is placed close to the second primary winding; and
a first magnetic core part and a second magnetic core part, wherein the first magnetic core part is placed in a gap between the first primary winding and the first secondary winding, and wherein the second magnetic core part is placed in a gap between the second primary winding and the second secondary winding.

9. The transformer pack of claim 8, wherein each one of the first secondary winding and the second secondary winding has two ends extended out of the bottom surface of the magnetic core.

10. The transformer pack of claim 8, wherein:
each one the first primary winding and the second primary winding has a segment passing through the magnetic core straightly and perpendicular to the top surface and the bottom surface of the magnetic core; and
each one of the first secondary winding and the second secondary winding has an upside-down “U” shape with two legs and a middle part connecting the two legs, wherein one of the legs of the first secondary winding is close to and parallel to the first primary winding, and one of the legs of the second secondary winding is close to and parallel to the second primary winding.

11. The transformer pack of claim 8, wherein:
each one of the first primary winding and the second primary winding passes through the magnetic core from the top surface to the bottom surface in a slant angle; and
each one of the first secondary winding and the second secondary winding has an upside-down “V” shape with two legs, wherein one of the legs of the first secondary winding is close to and parallel to the first primary winding, and one of the legs of the second secondary winding is close to and parallel to the second primary winding.

12. The transformer pack of claim 11, wherein projections of the first primary winding and the second primary winding to a first side surface of the magnetic core are overlapped, and the projections of the first primary winding and the second primary winding to a second side surface of the magnetic core are overlapped, and wherein the first side surface and the second side surface of the magnetic core are opposite.

13. The transformer pack of claim 11, wherein projections of the first primary winding and the second primary winding to a first side surface of the magnetic core are crossed, and the projections of the first primary winding and the second primary winding to a second side surface of the magnetic core are crossed, and wherein the first side surface and the second side surface of the magnetic core are opposite.

14. The transformer pack of claim 8, wherein:
each one of the first primary winding and the second primary winding has a “N” shape with a first segment extended from the top surface to the interior of the magnetic core, a second segment extended from the bottom surface to an interior of the magnetic core, and a third segment connecting the first segment and the second segment inside the magnetic core; and
each one of the first secondary winding and the second secondary winding has an upside-down “U” shape with two legs and a middle part connecting the two legs, wherein the middle part of the first secondary winding is under the third segment of the first primary winding, the middle part of the second secondary winding is under the third segment of the second secondary winding, and wherein one of the legs of the first secondary winding is close to and parallel to the second segment of the first primary winding, and one of the legs of the second secondary winding is close to and parallel to the second segment of the second primary winding.

15. The transformer pack of claim 14, wherein ends of the first segments of the first primary winding and the second primary winding extended out of the top surface of the magnetic core are aligned to a first side surface of the magnetic core, and wherein ends of the second segments of the first primary winding and the second primary winding extended out of the bottom surface of the magnetic core are aligned to a second side surface of the magnetic core, and wherein the first side surface of the magnetic core is opposite to the second side surface of the magnetic core.

16. The transformer pack of claim 14, wherein ends of the first segments of the first primary winding and the second secondary winding extended out of the top surface of the magnetic core are aligned to opposite side surfaces of the magnetic core, and wherein ends of the second segments of the two primary winding extended out of the bottom surface of the magnetic core are aligned to opposite side surfaces of the magnetic core.

17. The transformer pack of claim 14, wherein the first secondary winding and the second secondary winding are replaced by a single integral secondary winding, and wherein the single integral secondary winding comprises:
a first segment, under and parallel to the third segment of the first primary winding;
a second segment, under and parallel to the third segment of the second primary winding;
a third segment extended from the first segment of the single integral secondary winding to the bottom surface of the magnetic core;
a fourth segment extended from the second segment of the single integral secondary winding to the bottom surface of the magnetic core; and
a fifth segment connecting the first segment and the second segment inside the magnetic core.

18. A power module, comprising:
a transformer pack having a top surface and a bottom surface;
a top substrate mounted on the top surface of the transformer pack;
a bottom substrate mounted on the bottom surface of the transformer pack; and
a first power device chip and a second power device chip mounted on a top surface of the top substrate; wherein
each one of the first power device chip and the second power device chip comprises:
a switching pin;
a ground pin;
an input pin;
a driving pin;
a first power switch having a first terminal coupled to the input pin, a second terminal coupled to the switching pin, and a control terminal configured to receive a first driving signal;
a second power switch having a first terminal coupled to the switching pin, a second terminal coupled to the ground pin, and a control terminal configured to receive a second driving signal; and
a driver coupled to the driving pin to receive a phase control signal, and to provide the first driving signal and the second driving signal based on the phase control signal; wherein
the switching pin is electrically coupled to the transformer pack via the top substrate.

19. The power module of claim 18, wherein the transformer pack comprises:
a magnetic core;
a first primary winding and a second primary winding;
a first secondary winding and a second secondary winding; and
a first magnetic core part and a second magnetic core part; wherein
each one of the first primary winding and the second primary winding passes through the magnetic core, the first secondary winding is arranged close to the first primary winding with the first magnetic core part in between, and the second secondary winding is arranged close to the second primary winding with the second magnetic core part in between.

20. The power module of claim 19, wherein:
the first primary winding has a first end electrically coupled to a first plurality of output voltage pads on the bottom substrate, and a second end electrically coupled to the switching pin of the first power device chip via the top substrate; and
the second primary winding has a first end electrically coupled to a second plurality of output voltage pads on the bottom substrate, and a second end electrically coupled to the switching pin of the second power device chip via the top substrate.

21. The power module of claim 19, wherein the bottom substrate comprises a pad side surface having a pad array, and wherein the pad array comprises:
a first plurality of output voltage pads, electrically coupled to a first end of the first primary winding;
a second plurality of output voltage pads, electrically coupled to a first end of the second primary winding;
a plurality of ground pads, electrically coupled to the ground pins of the first power device chip and the second power device chip;
a plurality of input voltage pads, electrically coupled to the input pins of the first power device chip and the second power device chip; and
a plurality of signal pads, respectively and electrically coupled to corresponding pins of the first power chip device and the second power chip device.

22. The power module of claim 21, wherein the plurality of signal pads are lined up to one side of the pad side surface of the bottom substrate.

23. The power module of claim 22, wherein:
the plurality of input voltage pads are distributed in a line between lines of the plurality of ground pads and the line of the plurality of signal pads;
the first plurality of output voltage pads and the second plurality of output voltage pads are distributed in three lines, with the first plurality of output voltage pads at an upper side of the three lines and the second plurality of output voltage pads at a lower side of the three lines; and
the plurality of ground pads are distributed in the lines between lines of the first and second plurality of output voltage pads and the line of the plurality of input voltage pads.

24. The power module of claim 18, further comprising:
a connector configured to electrically connect pads on the top substrate and pads on the bottom substrate for passing signals between the top substrate and the bottom substrate.

25. The power module of claim 18, further comprising various discrete components mounted on the top surface of the top substrate.
